(19) United States
(12) Patent Application Publication
(10) Pub. No.: US 2011/0161540 A1
(43) Pub. Date: Jun. 30, 2011

(54) HARDWARE SUPPORTED HIGH PERFORMANCE LOCK SCHEMA

(75) Inventors: Xiao Tao Chang, Beijing (CN); Rui Hou, Beijing (CN); Yudong Yang, Beijing (CN); Hong Bo Zeng, Beijing (CN); Zhen Bo Zhu, Beijing (CN)

(73) Assignee: International Business Machines Corporation, Armonk, NY (US)

(21) Appl. No.: 12/975,579

(22) Filed: Dec. 22, 2010

(30) Foreign Application Priority Data
Dec. 22, 2009 (CN) 200910261073.5

(51) Int. Cl. G06F 12/00

(52) U.S. Cl. 710/200

(57) ABSTRACT

A method and apparatus for lock allocation control. When a processor core acquires a lock, other processor cores do not need to constantly poll memory to check whether the required lock is released. Instead, other processor cores will be in sleep state and the next processor core needed will be selectively woken up based on predetermined rule, such that an out-of-order lock contention procedure is turned into an in-order lock allocation procedure. By selectively waking up a processor core that is in sleep state, the method and apparatus can avoid occupying a large amount of bus bandwidth, can avoid cache misses, and can save power consumption of chip.

### TECHNICAL FIELD

The present invention relates generally to a process method and apparatus of computer system, in particular, to a method and apparatus of lock allocation control.

### DESCRIPTION OF THE RELATED ART

Multi-core processor refers to a single chip that contains a plurality of processor cores, the single chip can be inserted into a single processor slot directly, but operating system will utilize all associated resources, so that each processor core thereof will be used as a separate logic processor. By dividing tasks between two processor cores, the chip that contains multiple processor cores can perform more tasks during a specific clock period. Multi-core technology enables a server to handle tasks in parallel, a multi-core system is easier to expand, and can incorporate stronger process performance into more compact size, and such size will use less power consumption and heat produced by computing power consumption will be less.

In order to bringing more computation power, the multi-core technology presents great challenges in front of programmers of how to use them efficiently. Lock technology based on shared memory has long been one of the essential approaches adopted by programmers to provide mutually exclusive access to shared resource in shared memory. In a multi-core system, for example, in a dual-core system, there are two cores A, B that want to use a same lock, then when core A has acquired the lock, core B will be in block state until A has released the lock; at this time, only one of the two CPU cores is used, and the other one is in idle state; thus a phenomena of performing in serial will occur due to contention of lock by a plurality of cores, thereby substantially reducing multi-core performance.

FIG. 1 shows a diagram of a computer system for performing lock allocation in prior art. In FIG. 1, N1, N2, N3 are three computer nodes, each of them includes four processor cores C1, C2, C3, C4, and one or more processor cores in each node share a same local cache (L2 Cache), processor core interfaces with bus through shared local cache, such that cache coherence is ensured on L2 Cache, that is, when one memory variable exists in multiple caches, if variable information in any one of them changes due to operation, information in other caches also needs to be changed. If a plurality of processor cores in a plurality of nodes all want to acquire a certain lock in memory, the processor core that first issues a request will first acquire this lock, then it starts to perform read/write operation on a certain segment of data resource in memory. However, during this process, because all of the other processor cores do not know when the lock will be released, they will poll constantly to check when the lock in memory is released. Once the lock in memory is released, the process will start a next round of contention of lock. Such state of constant poll is also referred as “busy wait”. “Busy wait” is not an effective synchronization mechanism, it will waste a large amount of computation resource and it will also waste a large amount of bus resource because the processor cores will access memory constantly via bus, thereby bringing negative influence on overall processing capability.

### SUMMARY OF THE INVENTION

The present invention provides a novel method and apparatus for lock allocation control. According to the technical solution of the invention, when a processor core acquires a lock, other processor cores do not need to constantly poll memory to check whether the required lock is released, instead, other processor cores will be in sleep state, the invention will selectively wake up next processor core based on predetermined rule, such that an out-of-order lock contention procedure is turned into an in-order lock allocation procedure. By selectively waking up processor core that is in sleep state, the invention can avoid occupying a large amount of bus bandwidth and can save power consumption of chip. Further, the invention can also increase probability of obtaining data resource from cache by optimizing the predetermined rule, thereby reducing occurrence of cache miss.

Specifically, the invention provides a method for performing lock allocation for a plurality of processor cores, wherein the processor cores locate in computer node, and wherein a first processor core acquires a lock, while other processor cores that need to acquire said lock are in sleep state, the method including: receiving a signal that the first processor core has released said lock; determining a second processor core that should be woken up from other processor cores that need to acquire said lock and are in sleep state based on predetermined rule for allocating said lock; and waking up the second processor core to enable it to acquire said lock.

The invention further provides a lock allocation controller for performing lock allocation for a plurality of processor cores, wherein the processor cores locate in computer node, and wherein a first processor core acquires a lock, while other processor cores that need to acquire said lock are in sleep state, the lock allocation controller including: a lock state change receiving means for receiving a signal that the first processor core has released said lock; a target core determining means for determining a second processor core that should be woken up from other processor cores that need to acquire said lock and are in sleep state based on predetermined rule for allocating said lock; and a target core waking up means for waking up the second processor core to enable it to acquire said lock.

The invention also provides a computer system, including a plurality of processor cores, at least one cache, and the lock allocation controller as described above.

The above description illustrates some advantages of the invention on the whole, and these and other advantages thereof will become more apparent from drawings in conjunction with detailed description of the preferred embodiment of the invention.

### BRIEF DESCRIPTION OF THE DRAWINGS

The drawings referred in the description are only used to illustrate typical embodiments of the invention, and should not be considered as a limitation on the scope of the invention.

FIG. 1 shows a diagram of a computer system for performing lock allocation in prior art.

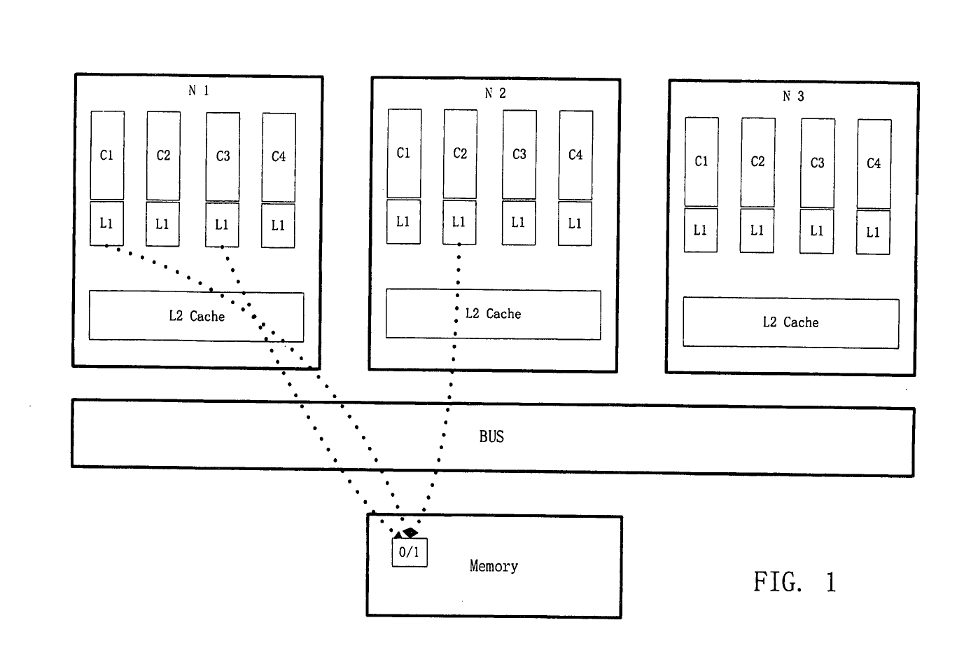

FIG. 2 shows a diagram of a computer system that employs a lock allocation controller in a single computer node.

FIG. 3 shows a diagram of a lock allocation controller in a single computer node.

FIG. 4 shows a diagram of a computer system that employs lock allocation controller in multiple computer nodes.

FIG. 5 shows a diagram of the lock allocation controller of computer node N1 in FIG. 4.

FIG. 6 shows a diagram of the lock allocation controller of computer node N2 in FIG. 4.

FIG. 7 shows a flow diagram of a lock allocation control method.

FIG. 8 shows a flow diagram of employing lock allocation control method in a single computer node.

FIG. 9 shows a flow diagram of employing lock allocation control method by using home note in multiple computer nodes.

FIG. 10 shows a flow diagram of employing lock allocation control method by using auxiliary note in multiple computer nodes.

### DETAILED DESCRIPTION OF THE PREFERRED EMBODIMENT

In the following discussion, a large amount of specific details are provided to facilitate to understand the invention thoroughly. However, for those skilled in the art, it is evident that it does not affect the understanding of the invention without these specific details. And it will be recognized that, the usage of any of following specific terms is just for convenience of description, thus the invention should not be limited to any specific application that is identified and/or implied by such terms.

Unless otherwise stated, the function described in the invention may be operated by software or hardware or combination thereof. However, in an embodiment, unless otherwise stated, these functions are performed by processors (such as computers or electric data processors) based on encoded integrated circuits (such as encoded by computer programs).

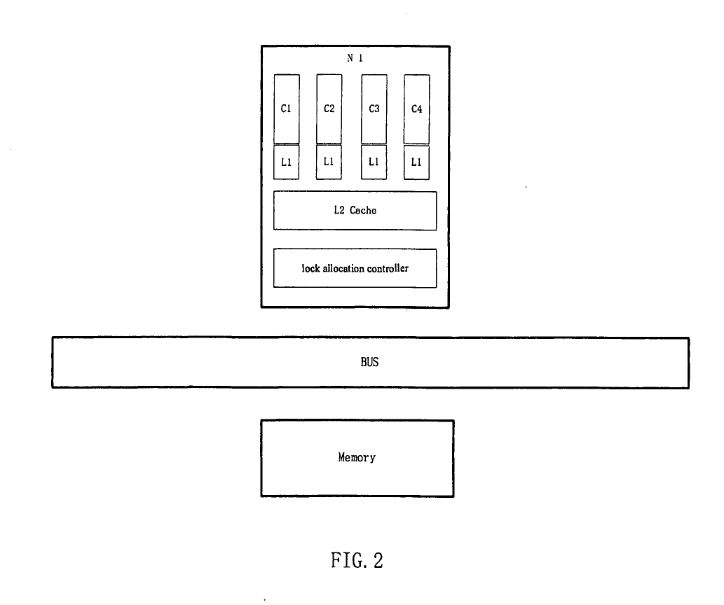

FIG. 2 shows a diagram of a computer system that employs a lock allocation controller in a single computer node. In this computer system, computer chip (not shown in the figure) includes one computer node N1 and a bus. N1 contains four processor cores C1, C2, C3 and C4. These four processor cores share a same level of local cache (L2 Cache), and processor cores communicate with the bus through shared local cache, and in turn may read/write data in memory. At the same time, a special hardware mechanism is responsible for ensuring data coherence of each L2 Cache. As can be appreciated by those skilled in the art, these four processor cores are not limited to share level 2 cache, but can also share level 3 cache, level 4 cache etc; what is described in FIG. 2 is merely one embodiment of the invention and it is not a limitation to the invention. Each process core may support one hardware thread, or may support multiple hardware threads, and each process core or hardware thread is coupled to one level 1 cache.

A unique feature of the invention is that a lock allocation controller is provided in computer node N1, such that computer core can perform occupying and releasing operation of lock without accessing memory through bus, rather, information associated with lock may be stored in the computer node. This can reduce resource waste on bus, and can also reduce time delay due to accessing memory through bus. As can be appreciated by those skilled in the art, the speed at which processor core accesses memory through bus is significantly slower than the speed at which processor core accesses inside of computer node. Computer node not only can store lock state information, but also can deploy associated operation logic therein, such that it can selectively wake up the processor cores that are in sleep state based on predetermined rule.

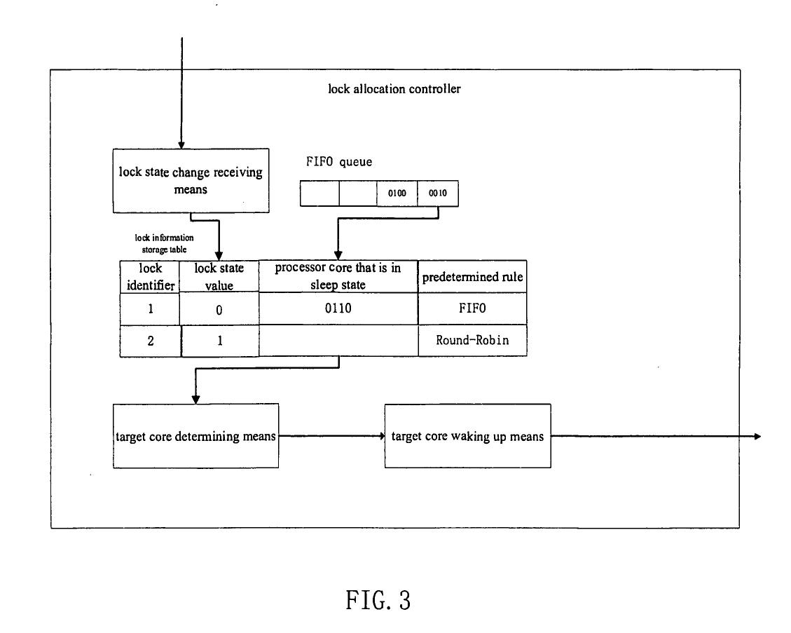

FIG. 3 shows a diagram of a lock allocation controller in a single computer node. The lock allocation controller includes a lock state change receiving means, a lock information storage table, a target core determining means, a target core waking up means, and preferably includes a first in first out queue (FIFO queue). The lock information storage table stores therein associated information of each lock, including lock identifier (Lock ID), lock state value (Valid), processor cores that are in sleep state (Core in waiting), and predetermined rule (Policy). Thus, in the invention, the information associated with lock is not stored in memory, but is stored in lock allocation controller of computer node; since the time needed for computer core to access lock allocation controller is significantly shorter than the time needed for it to assess memory through bus, the invention greatly reduces time delay in contention of lock.

The lock state change receiving means is used to receive a change of lock state from processor core. In particularly, according to an embodiment of the invention, bit 1 represents that lock state is idle, and bit 0 represents that lock is currently occupied. When lock state is idle (i.e. the value of lock state is 1), the lock allocation controller receives a request that processor core wants to access a certain lock through lock state change receiving means, and modifies lock state value, such that the lock state value is 0, and other processor cores know that this lock has been occupied. It can be known from the content in the lock information storage table of FIG. 3 that, lock with identifier 1 is currently occupied by a certain processor core (for example, it is currently occupied by core C1 with identifier 1000), while there are two processor cores that are in sleep state and wait to acquire lock 1 in FIFO queue. The FIFO queue records therein identifiers 0010 (core C3) and 0100 (core C2) of two processor cores that issue a request signal for lock 1 sequentially in time sequence. These two processor cores can be identified by only 4 bits (0110) in the lock information storage table. Of course, as can be appreciated by those skilled in the art, more bits can be used to identify local processor cores that are in sleep state, such as 0010 and 0100. Further, the lock state change receiving means is used to receive a signal that the C1 core has released lock 1. According to one embodiment of the invention, the lock state change receiving means can further modify lock state value in the lock information storage table to change it from 0 (occupied) to 1 (idle). According to another embodiment of the invention, if it is detected that there is processor core that is in idle state in the lock information storage table, which implies that there is processor core that needs to acquire lock 1, then lock state change receiving means will not modify lock state value, rather, a certain processor core that is in idle state may be waken up by the target core determining means and the target core waking up means.

Policy records therein predetermined rule for managing lock allocation. According to one embodiment of the invention, the predetermined rule is first in first out rule, that is, for a plurality of processor cores that are all in sleep states to wait for a certain lock, the lock allocation controller will wake up the processor core that first issues lock request preferentially. According to another embodiment of the invention, predetermined rule is round-robin rule, that is, for a plurality of processor cores that are all in sleep states to wait for a certain lock, the lock allocation controller will calculate round-robin queue based on round-robin rule, and wake up the processor core that has the highest priority in round-robin queue preferentially. The principal of round-robin rule is to allocate lock to processor core that issues request in turn. Of course, the invention is not limited to these two predetermined rules, rather, any predetermined rule can be applied to allocate lock. As shown in lock information storage table in FIG. 3, lock 2 is in idle state, and the predetermined rule applied is round-robin rule.

The target core determining means is used to judge which processor core that is in sleep state may be woken up based on predetermined rule after lock state value is changed from 0 to 1. According to the embodiment in FIG. 3, after lock 1 is released, processor C3 (identifier 0010) will be woken up. The target core waking up means is used to issue a waking up signal to C3. After acquiring lock 1, C3 first judges whether data resource to be accessed that corresponds to lock 1 could be found in cache (level 1 cache, level 2 cache or other level of cache); and if the data resource to be accessed can not be found, C3 will access memory through bus to acquire the data resource to be accessed.

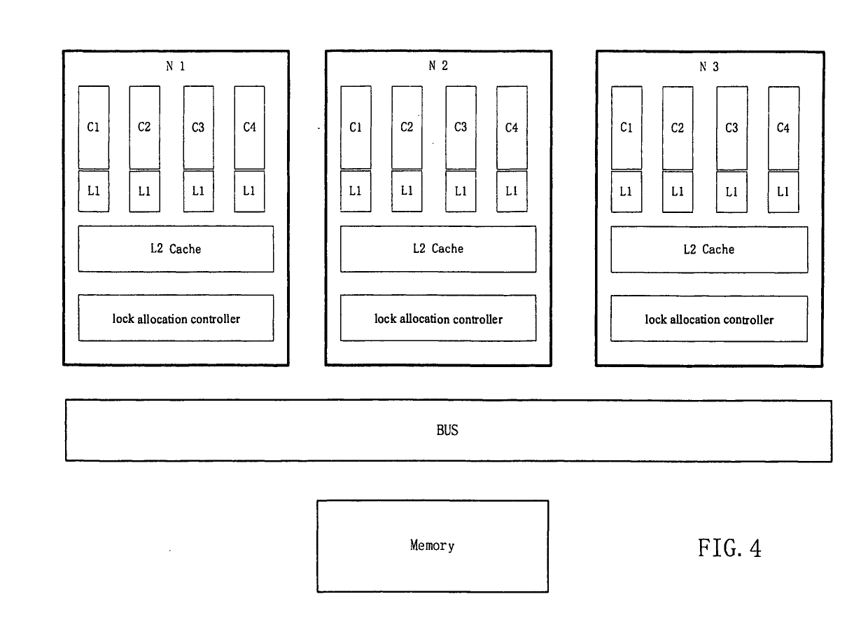

FIG. 4 shows a diagram of a computer system that employs lock allocation controller in multiple computer nodes. According to the embodiment shown in FIG. 4, computer chip includes three computer nodes N1, N2, N3, and one bus. Computer nodes access memory through the bus. The internal structure of computer node in FIG. 4 is substantially the same as that of computer node in FIG. 2, and the description of which will be omitted for brevity.

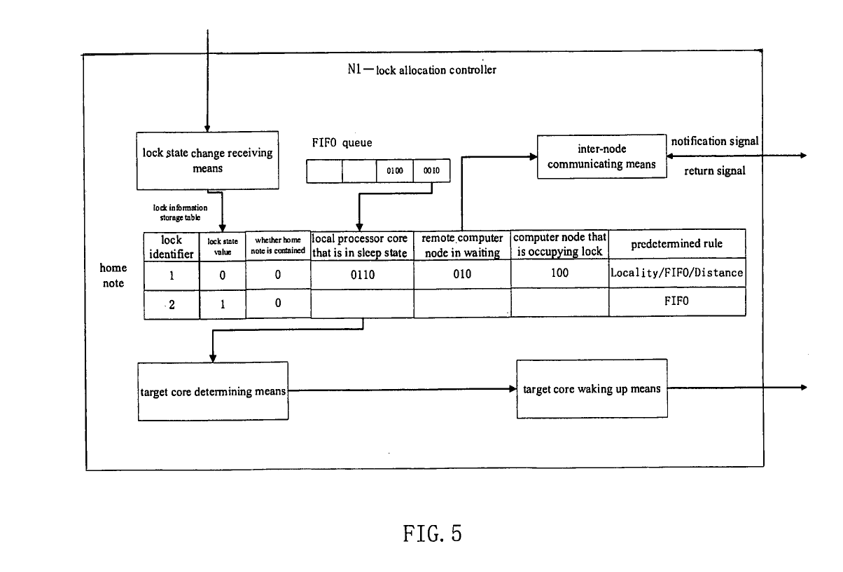

Applying lock allocation controller in multiple computer nodes differs from applying lock allocation controller in a single computer node in that, a same lock needs to be allocated among a plurality of computer nodes, so there is a need for a mechanism to ensure that a plurality of lock allocation controllers can coordinate with each other on the allocation of a same lock and to further reduce time delay due to inter node communication. The coordination mechanism will be described in detail in FIG. 5.

FIG. 5 shows a diagram of the lock allocation controller of computer node N1 in FIG. 4. There are similarities between the lock allocation controller in FIG. 5 and the lock allocation controller in FIG. 3, and for those elements having same function, only a simple description will be given below.

The lock allocation controller in N1 includes a lock state change receiving means, a lock information storage table, a target core determining means, a target core waking up means, an inter-node communicating means, and preferably includes a first in first out queue (FIFO queue). The lock information storage table stores therein associated information of each lock, including lock identifier (Lock ID), lock state value (Valid), whether a Home Note, also referred to as home note, is contained, local core in waiting, remote node in waiting, computer node that is occupying lock (Current holder) and predetermined rule (Policy).

The lock state change receiving means is used to receive a change of lock state from processor core, including receiving lock request and lock release signal. In order to coordinate lock information storage tables in respective lock allocation controllers, according to one embodiment of the invention, one home note and several auxiliary notes are established for each lock, and these notes are deployed in lock allocation controllers of different computer nodes respectively. As shown in FIG. 5, home note of lock 1 is deployed in node N1, and auxiliary notes of lock 1 are deployed in nodes N2 and N3. Both the home and auxiliary notes are used to record status of the supported computer node's demand for lock, and the home note is additionally responsible for coordinating the allocation of lock among different computer nodes.

It can be known from the content in lock information storage table in FIG. 5 that, lock 1 is currently occupied by a certain processor core (for example, it is currently occupied by C1 in N1), while there are two local processor cores in FIFO queue that are in sleep state and wait to acquire lock 1. FIFO queue records therein identifiers 0010 (core C3) and 0100 (core C2) of two processor cores that issue a request signal for lock 1 sequentially in time sequence. Remote computer node containing remote processor core that is in sleep state is recorded a column of remote computer node in waiting, thus 010 is recorded in the column of remote computer node in waiting, which represents that computer node N2 contains processor core that is waiting for lock 1. The computer node that is occupying lock is recorded in a column of computer node occupying lock, thus 100 is recorded in the column of computer node occupying lock, which represents that processor core in N1 is occupying lock 1. According to the embodiment in FIG. 5, the home note needs not to know remote processor core that needs to access lock 1, because the control of waking up remote processor core can be entirely completed by lock allocation controller deployed in remote computer node. It can be seen that, home note is used to support lock allocation to local processor core, and to support lock allocation between coordinated nodes, while auxiliary note is only used to support lock allocation to local processor core.

According to an embodiment of the invention, whether a lock allocation controller contains home note can be judged from whether it contains a value of home note. There are various ways of allocating home note. The basic idea can be divided into two types, in which the first one is to evenly (to the best of its ability) allocate a plurality of locks into different computer nodes. If there are 999 locks in total, then 999 home notes of the 999 locks may be evenly divided into three portions, that is, each portion contains 333 locks, thus lock allocation controller of each computer node contains 333 home notes and 666 auxiliary notes. The content about auxiliary notes will be described in detail below. There are also various types of logic for allocating lock, in which a simpler approach is to perform modular operation (such as perform operation with modulo 3) on ID number of a lock, and then allocate home notes based on mantissa (such as 1, 2 or 3) after the operation. According to an embodiment of the invention, processor core may perform logic operation with modulo 3 each time it accesses lock allocation controller, so as to calculate computer node that stores home note of lock. According to another embodiment of the invention, one bit in lock information storage table can be used to identify whether the note is a home note; in the example of FIG. 5, 0 is used to represent that the note is home note and 1 is used to represent that the note is auxiliary note; such that there is no need for the processor core to perform modular operation when it accesses lock allocation controller, rather, the processor core can judge location of home note by checking table directly. It should be noted that, the allocation of lock can be performed in advance. That is, some basic information in lock information storage table, including lock ID, lock state value, whether it contains home note and predetermined rule, can be determined and stored in advance.

A second way to allocate home note is to allocate (to the best of its ability) home note of a lock into lock allocation controller corresponding to processor core that frequently needs to use the lock, thereby reducing time delay due to synchronize auxiliary note with home note and further optimizing the performance of lock allocation. Programmers can either allocate home note of lock in frequently accessed computer nodes manually based on their own experience, or they can judge which lock is more frequently accessed by which computer node based on feedback of system operation, that is, they can collect statistics on feedback result, so as to create a recommended scheme for allocating home note of lock.

Moreover, the invention can also only store home note but not auxiliary note. Accordingly, if a processor core can not find home note of the requested lock in lock allocation controller of the node where that core is located, then it can communicate with computer node where home note is located to acquire the requested lock, or that core may be placed in a waiting queue.

Predetermined rule for lock allocation is recorded in the predetermined rule in lock information storage table. Locality/FIFO/Distance represents that local processor core will be woken up preferentially when all the processor cores from different computer nodes want to acquire lock 1, and control right of the lock is delivered to remote computer node when all the local processor cores have ended occupation of lock 1; and if two or more local processor cores want to occupy lock 1, the lock allocation controller will preferentially allocate lock 1 to process core (0010) which is preceding in time sequence according to FIFO rule; if two or more remote computer nodes (such as N2 and N3) all contain processor cores that are in sleep state and are waiting for the occupation of lock 1, then the lock allocation controller will preferentially allocate lock 1 to remote computer node that is physically closest to local computer node (N1) (if the physical distance between N2 and N1 is shorter than the physical distance between N3 and N1, processor core in N2 will occupy lock 1 after processor core in N1 has finished occupying lock 1); thereby further saving time delay in allocating lock and optimizing performance of lock allocation. Further, there may be two embodiments for achieving the occupation of lock 1 by processor core in N2. According to the first embodiment, the lock allocation controller in N1 will notify the lock allocation controller in N2; then processor core in N2 will be woken up by the lock allocation controller in N2. According the second embodiment, the lock allocation controller in N1 will directly wake up processor core in N2, in this case, the lock allocation controller in N1 needs to record remote process core that needs to acquire lock 1 and the computer node thereof.

As can be appreciated by those skilled in the art, the predetermined rule may have many variations, for example, if the predetermined rule is Locality/FIFO/FIFO, then it represents that local computer node has priority over remote computer node, and at local, the allocation of lock will be performed based on the sequence of first in first out, and among different remote computer nodes, the allocation of lock will also be performed based on the sequence of first in first out. Further, if the predetermined rule is Locality/Round-Robin/ FIFO, then it represents that local computer node has priority over remote computer node, and at local, the allocation of lock will be performed based on a preference sequence obtained from round-robin rule, and among different remote computer nodes, the allocation of lock will also be performed based on the sequence of first in first out. Still further, if the predetermined rule is FIFO, then it represents that whether local processor core or remote processor core will occupy lock based on the sequence of first in first out, in this case, FIFO queue records therein not only identifier of local processor core, but also identifiers of all the processor cores that need to occupy lock and identifiers of computer nodes corresponding to these processor cores.

Target core determining means is used to judge which of the local processor cores that are in sleep state will be woken up based on predetermined rule after lock state value is changed from 0 to 1. According to the embodiment in FIG. 5, after lock 1 is released, C3, C2 in N1 will be woken up in sequence; when there is no thread in N1 that is in sleep state, the allocation of lock 1 will be controlled by the lock allocation controller in N2. Target core waking up means is used to issue a waking up signal to processor core, for example, issue a waking up signal to C3, C2 in N1. When both C3 and C2 have ended the occupation of lock 1, the lock allocation controller in N1 will issue a notification signal to N2 through an inter-node communicating means, to deliver control right of lock 1 to the lock allocation controller in N2. In one embodiment, after the processor core in N2 has released lock 1, N1 will confirm that N2 returns the control right of lock 1 to N1 through the inter-node communicating means, for example, N1 will receive from N2 a signal that control right of lock 1 has been returned, and further, N1 can query the lock information storage table in N2 to confirm that control right of lock 1 has been returned. In another embodiment, after processor core in N2 has released lock 1, N2 will deliver control of lock 1 to the computer node (such as N3) where next processor core that needs to acquire lock 1 is located through the inter-node communicating means of N2; and in order to keep synchronization between lock allocation controllers, N1 will confirm that N2 has delivered control of lock 1 to the next computer node. N2 can send a notification signal to N3 to deliver control right of lock 1 to N3. N2 can proactively notify N1 that control right of lock 1 is delivered to N3, or N1 can proactively query N2 to confirm that control right of lock 1 has been delivered to N3.

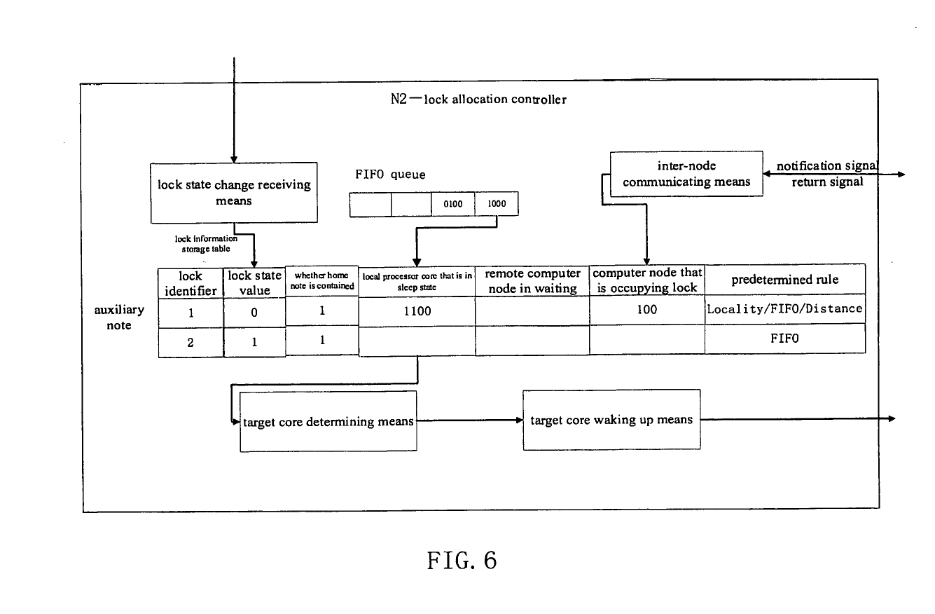

FIG. 6 shows a diagram of the lock allocation controller of computer node N2 in FIG. 4. The lock allocation controller in N1 stores home note of lock 1, and the lock allocation controller in N2 stores auxiliary note of lock 1. According to one embodiment of the invention, the structure of lock information storage table in FIG. 5 is the same as that in FIG. 6. In auxiliary note of lock 1, values of remote computer nodes in waiting can be omitted; because N 2 will return control right of lock 1 to N1 through a return signal sent via an inter-node communicating means after processor core in N2 has released lock 1; and since N1 contains home note of lock 1, there is no need for N2 to keep values of remote computer nodes in waiting. As to other values in auxiliary notes of lock 1, including identifier of lock, lock state value, whether home note is contained, local processor core that is in sleep state, computer node that is occupying lock, and value of predetermined rule, they will be kept in synchronization with value of home note of lock 1.

As a variation to the above embodiment, the invention will not distinguish home note from auxiliary note, and will set values of home note and auxiliary note in lock allocation controller to be completely identical. Thus, after all the processor cores in a node have ended occupation of lock 1, each computer node can directly deliver control right of lock 1 to another computer node without having to communicate with the computer node where home note is located. For example, N1, N2, N3 all need to occupy lock 1, after N1 has ended occupation of lock 1, control right is delivered to N2, and after N2 has ended occupation of lock, control right is directly delivered to N3; in order to keep synchronization among the lock allocation controllers, N1 will confirm that N2 has delivered control right of lock 1 to the next computer node.

According to the embodiment in FIG. 6, lock state value=0 indicates that lock 1 is being occupied; value of whether home note is contained is 1 represents that this note is an auxiliary note; value of local processor core that is in sleep state is 1100 represents that two local processor cores 1000 and 0100 in N2 are both in sleep state and are waiting for the allocation of lock 1; value of computer node that is occupying lock is 100 represents the current computer node that is occupying lock 1 is N1; value of predetermined rule contains predetermined rules for allocating lock corresponding to lock 1.

Based on predetermined rule of Locality/FIFO/Distance of lock 1, once N1 issues a node waking up signal to N2 through the inter-node communicating means, N2 will judge which local processor core should be woken up based on its own auxiliary note. When processor core in N2 ends the occupation of lock 1 in a sequence of first in first out, N2 will send a return signal to N1 through the inter-node communication means, and give control right of lock 1 back to N1 again. Thus, processor core of each computer node can complete occupying and releasing operation of lock by merely communicating with local lock allocation controller.

After C1 (1000) in N2 has released lock 1, C2 (0100) in N2 occupies lock 1 again; at this time, there is no need for hardware thread on the C2 to access memory again so as to reading/writing data resource, rather, it may first attempt to obtain data resource corresponding to lock 1 from cache of N2; if corresponding data resource is stored in cache of N2, C2 does not need to access memory, thereby saving the resource of bus and saving the time needed to access data resource. If corresponding data resource is not stored in cache of N2, for example, the data in cache has been updated, then C2 will access memory again to obtain the needed data resource.

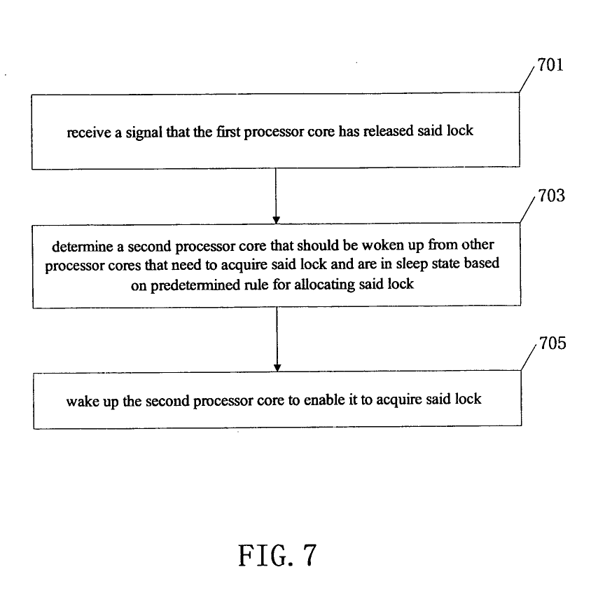

FIG. 7 shows a flow diagram of a lock allocation control method. Assume a first processor core acquires a lock for a piece of data resource in memory, and other processor cores that need to acquire said lock are in sleep state. A signal that the first processor core has released said lock is received in step 701. A second processor core that should be woken up is determined from other processor cores that need to acquire said lock and are in sleep state based on predetermined rule for allocating said lock in step 703. The second processor core is woken up to enable it to acquire said lock in step 705.

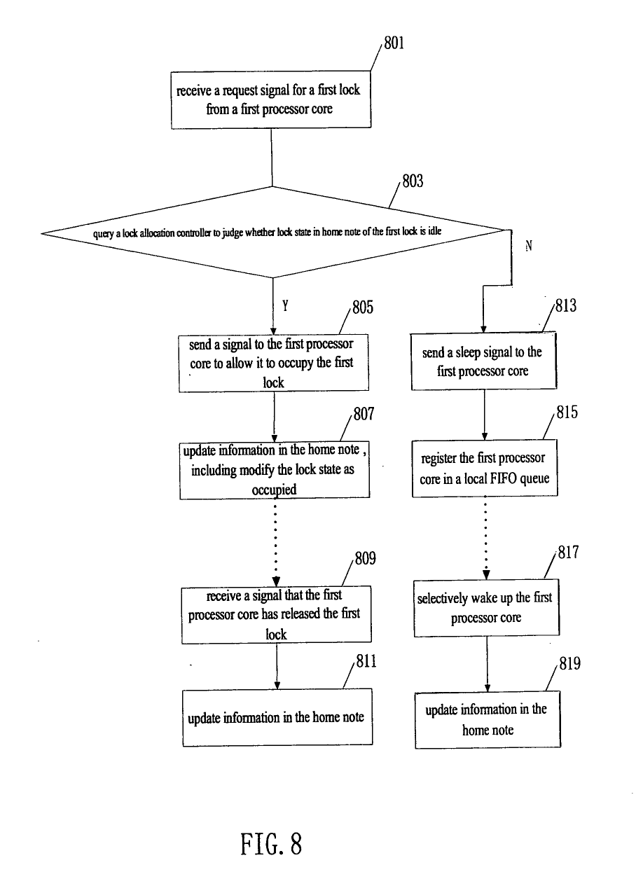

Specifically, FIG. 8 shows a flow diagram of employing lock allocation control method in a single computer node. A request signal for a first lock is received from a first processor core in step 801. A lock allocation controller is queried to judge whether lock state in home note of the first lock is idle in step 803. If idle, a signal is sent to the first processor core to allow it to occupy the first lock in step 805. Further, information in the home note is updated in step 807, which includes modifying the lock state as being occupied. After the first processor core has released the first lock, a signal that the first processor core has released the first lock is received in step 809, and information in the home note is updated in step 811, which includes updating lock state information of the first lock.

If it is judged that the lock state in home note of the first lock is being occupied in step 803, a sleep signal is sent to the first processor core in step 813, such that it enters into sleep state and will not constantly poll lock state information of the first lock. The first processor core is registered in a local FIFO queue in step 815 to wait for subsequent waking up operation. The FIFO queue herein is merely illustrative, and any other algorithm may be used to order the processor cores that are in sleep state. After the first lock is released, the first processor core is selectively woken up based on predetermined rule in step 817, and information in home note is updated in step 819, which includes deleting first processor from value of the processor cores in home note that are in sleep state, shifting and updating information of processor cores in the FIFO queue correspondingly.

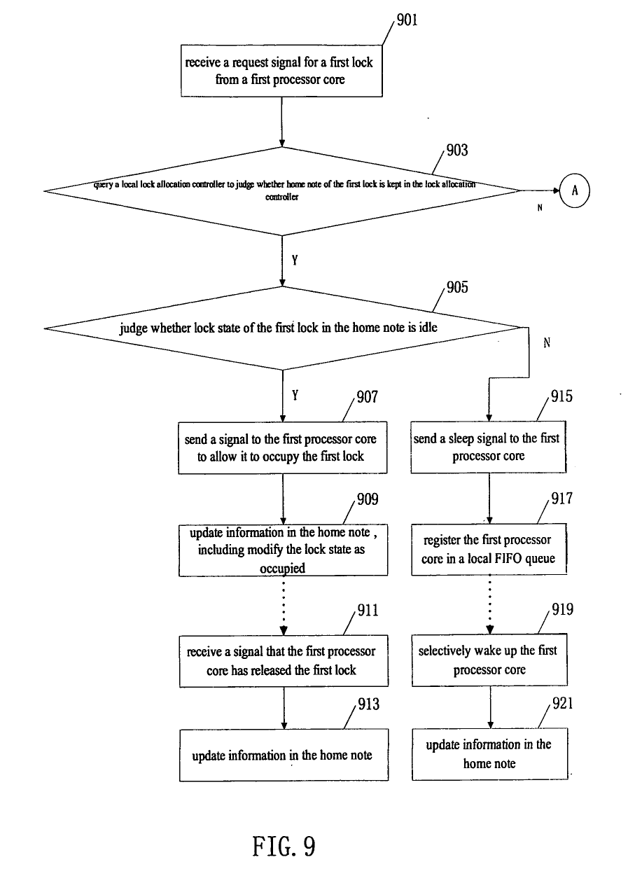

FIG. 9 shows a flow diagram of employing lock allocation control method by using home note in multiple computer nodes. A request signal for a first lock is received from a first processor core in step 901. A local lock allocation controller is queried to judge whether home note of the first lock is kept in the lock allocation controller in step 903. If home note is kept, it is further judged whether lock state in the home note is idle in step 905. If idle, a signal is sent to the first processor core to allow it to occupy the first lock in step 907. Further, information in the home note is updated in step 909, which includes modifying lock state as being occupied and further includes modifying value of computer node that is occupying lock as computer node where the first processor core is located. If the first processor core has ended occupation of the first lock, a signal that the first processor core has released the first lock is received in step 911. And, information in the home note is updated in step 913, which includes changing lock state information to idle, and deleting content in computer node that is occupying the lock.

If it is judged that lock state of the first lock in the home note is occupied in step 905, a sleep signal is sent to the first processor core to enable it to enter into sleep state. The first processor core is registered in a local FIFO queue to wait for processing in order in step 917. After the first lock is released, the first processor core is selectively woken up based on predetermined rule in step 919. And, information in home note is updated in step 921, which includes deleting the first processor core from the local processor cores that are in sleep state, shifting and updating information of processor cores in the FIFO queue correspondingly.

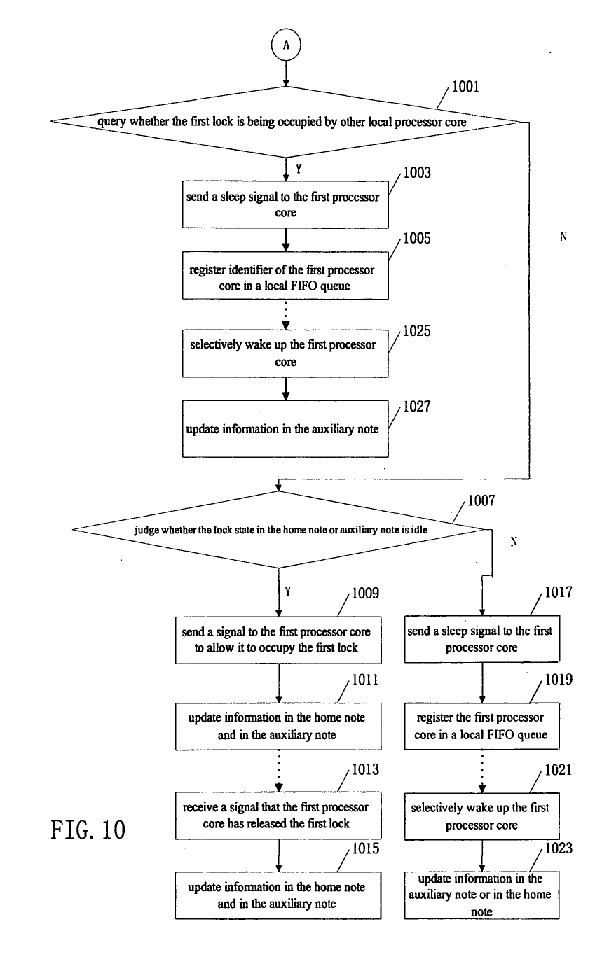

FIG. 10 shows a flow diagram of employing lock allocation control method by using auxiliary note in multiple computer nodes. In step 903 of FIG. 9, if it is judged by querying local lock allocation controller that home note of the first lock is not kept in the lock allocation controller, that is, what is kept in the lock allocation controller is auxiliary note of the first lock, then it is further queried whether the first lock is being occupied by other local processor core in step 1001. This step can be performed by querying whether node in the computer node that is occupying lock in lock information storage table is a node where the first processor core is located. If the first lock is occupied by other processor core of computer node where the first processor core is located, a sleep signal is sent to the first processor core to enable it enter into sleep state in step 1003. The identifier of the first processor core is registered in a local FIFO queue to wait for acquiring the first lock in order in step 1005. If the first lock is released, the first processor core may be selectively woken up based on predetermined rule to enable it to occupy the first lock in step 1025. And, information in the auxiliary note is updated in step 1027. The updating of information in auxiliary note includes deleting the first processor core from the local processor cores that are in sleep state, shifting and updating information of processor cores in the FIFO queue correspondingly.

If it is queried that the first lock is not occupied by other processor core of computer node where the first processor core is located in step 1001, then it is judged whether lock state in the home note is idle in step 1007. As can be appreciated by those skilled in the art, if home note is synchronized with auxiliary note, the auxiliary note can also be queried as to whether lock state is idle. In summary, when the lock state of the first lock is idle, a signal is sent to the first processor core to allow it to occupy the first lock in step 1009. And, information in home note and auxiliary note are updated in step 1011, which further includes updating lock state information of the first lock in home note and auxiliary note and information in the computer node that is occupying the lock.

When the first processor core ends the occupation of the first lock, a signal that the first processor core has released the first lock is received in step 1013. Information in home note and auxiliary note are updated in step 1015, which includes updating lock state information in home note and auxiliary note and information in the computer node that is occupying the lock.

If it is judged that the lock state in the home note is occupied in step 1007, a sleep signal is sent to the first processor core such that it enters into sleep state in step 1017. And, the first processor core is registered in a local FIFO queue in step 1019.

After the first lock is released, the first processor core is selectively woken up based on predetermined rule to enable it to occupy the first lock in step 1021, and information in the auxiliary note or home note is updated in step 1023, which includes updating the computer node that is occupying lock to the computer node where the first processor core is located. And, updating of information in an auxiliary note further includes deleting the first processor core from the local processor cores that are in sleep state, shifting and updating information of processor cores in the FIFO queue correspondingly.

Various embodiments of the invention can provide many advantages, including those that are illustrated in summary of the invention and those that can be derived from technical solution per se. However, whether one embodiment can gain all advantages and whether such advantages are considered as a substantial improvement should not be considered as a limitation to the invention. Meanwhile, various implementations mentioned above are merely for illustration purpose, those skilled in the art can make various modifications and alterations to the above implementations without departing from the substance of the invention. The scope of the invention is entirely defined by the appended claims.

1. A method for performing lock allocation for a plurality of processor cores, and wherein a first processor core acquires a lock, while other processor cores that need to acquire said lock are in sleep state, the method including:
receiving a signal that the first processor core has released said lock;
determining a second processor core that should be woken up from other processor cores that need to acquire said lock and are in sleep state based on a predetermined rule for allocating said lock; and
waking up the second processor core to enable it to acquire said lock.

2. The method according to claim 1, further including:
creating a lock information storage table for said lock to record identifier of said lock, state value of said lock, identifier of at least one processor core that needs to acquire said lock and is in sleep state, and a predetermined rule for allocating said lock.

3. The method according to claim 2, further including:
updating information in the lock information storage table if the second processor core has acquired said lock.

4. The method according to claim 2, wherein the plurality of processor cores include remote processor cores and local processor cores, and said predetermined rule for allocating said lock includes:
allocating said lock to local processor cores preferentially if processor cores that need to acquire said lock and are in sleep state include both local processor cores and remote processor cores.

5. The method according to claim 4, wherein said predetermined rule for allocating said lock further includes:
preferentially allocating said lock to a remote processor core in a remote computer node that is physically closer to a first computer node where the first processor core is located if multiple remote computer nodes all contain remote processor cores that need to acquire said lock and are in sleep state.

6. The method according to claim 4, wherein the second processor core and the first processor core are located in different computer nodes respectively, and the method further including:
notifying a computer node where the second processor core is located to enable the computer node where the second processor core is located to wake up the second processor core that is in sleep state.

7. The method according to claim 6, further including:
confirming that the computer node where the second processor core is located returns control of said lock to the computer node where the first processor core is located after the second processor core has released said lock.

8. The method according to claim 6, further including:
confirming that the computer node where the second processor core is located delivers control of said lock to the computer node where a next processor core that needs to be woken up is located after the second processor core has released said lock.

9. The method according to claim 4, wherein the identifier of at least one processor core that needs to acquire said lock and is in sleep state recorded in the lock information storage table is an identifier of a local processor core that needs to acquire said lock and is in sleep state, and the lock information storage table further records identifiers of remote computer nodes where remote processor cores that need to acquire said lock and are in sleep state are located.

10. A lock allocation controller for performing lock allocation for a plurality of processor cores, and wherein a first processor core acquires a lock, while other processor cores that need to acquire said lock are in sleep state, the lock allocation controller including:
a lock state change receiving means for receiving a signal that the first processor core has released said lock;
a target core determining means for determining a second processor core that is in sleep state and should be woken up from other processor cores that need to acquire said lock and are in sleep state based on predetermined rule for allocating said lock; and
a target core waking up means for waking up the second processor core to enable it to acquire said lock.

11. The lock allocation controller according to claim 10, further including:
a lock information storage table that is created for said lock for recording an identifier of said lock, state value of said lock, an identifier of at least one processor core that needs to acquire said lock and is in sleep state, and a predetermined rule for allocating said lock.

12. The lock allocation controller according to claim 11, wherein the lock information storage table is updated if the second processor core has acquired said lock.

13. The lock allocation controller according to claim 11, wherein the plurality of processor cores include remote processor cores and local processor cores, and said predetermined rule for allocating said lock includes:
preferentially allocating said lock to local processor cores if processor cores that need to acquire said lock and are in sleep state include both local processor cores and remote processor cores.

14. The lock allocation controller according to claim 13, wherein said predetermined rule for allocating said lock further includes:
preferentially allocating said lock to a remote processor core in a remote computer node that is physically closer to a first computer node where the first processor core is located if multiple remote computer nodes all contain remote processor cores that need to acquire said lock and are in sleep state.

15. The lock allocation controller according to claim 13, wherein the second processor core and the first processor core are located in different computer nodes respectively, and the lock allocation controller further including:
an inter-node communicating means for notifying a computer node where the second processor core is located to enable the computer node where the second processor core is located to wake up the second processor core that is in sleep state.

16. The lock allocation controller according to claim 15, the inter-node communicating means is further adapted to confirm that the computer node where the second processor core is located returns control of said lock to the first computer node where the first processor core is located after the second processor core has released said lock.

17. The lock allocation controller according to claim 15, the inter-node communicating means is further used to confirm that a second computer node where the second processor core is located delivers control of said lock to the computer node where a next processor core that needs to be woken up is located after the second processor core has released said lock.

18. The lock allocation controller according to claim 13, wherein an identifier of at least one processor core that needs to acquire said lock and is in sleep state recorded in the lock information storage table is an identifier of a local processor core that needs to acquire said lock and is in sleep state, and the lock information storage table further records identifiers of remote computer nodes where remote processor cores that need to acquire said lock and are in sleep state are located.

19. A computer system comprising:
a plurality of processor cores;
at least one cache; and
lock allocation controller for performing lock allocation for a plurality of processor cores, and wherein a first processor core acquires a lock, while other processor cores that need to acquire said lock are in sleep state, the lock allocation controller including:
a lock state change receiving means for receiving a signal that the first processor core has released said lock;
a target core determining means for determining a second processor core that is in sleep state and should be woken up from other processor cores that need to acquire said lock and are in sleep state based on predetermined rule for allocating said lock; and
a target core waking up means for waking up the second processor core to enable it to acquire said lock.
